(19) United States
(12) Patent Application Publication
(10) Pub. No.: US 2015/0363087 A1
(43) Pub. Date: Dec. 17, 2015

(54) DISPLAY APPARATUS FOR VEHICLE, VEHICLE WITH DISPLAY APPARATUS AND METHOD OF CONTROLLING DISPLAY APPARATUS

(71) Applicant: HYUNDAI MOTOR COMPANY, Seoul (KR)

(72) Inventor: Seunghwan LEE, Hwaseong-si (KR)

(21) Appl. No.: 14/562,293

(22) Filed: Dec. 5, 2014

(30) Foreign Application Priority Data
Jun. 11, 2014 (KR) 10-2014-0070834

(51) Int. Cl. G06F 3/0484; G06T 3/40

(52) U.S. Cl. CPC G06F 3/04847; G06T 3/40; G06F 3/04842; G06T 2207/20092

(57) ABSTRACT

Disclosed herein are a display apparatus for a vehicle, a vehicle with the display apparatus and a method of controlling the display apparatus. The display apparatus for a vehicle includes a display unit having a plurality of display regions to respectively display information thereon, and an input unit configured to receive a selection command to select one of the display regions. The display region selected according to the selection command is expanded to display detailed information, and the display region other than the selected display region displays brief information.

### CROSS-REFERENCE TO RELATED APPLICATION

This application claims the benefit of Korean Patent Application No. 2014-0070834, filed on Jun. 11, 2014 in the Korean Intellectual Property Office, the disclosure of which is incorporated herein by reference.

### BACKGROUND

1. Field

Embodiments of the present invention relate to a display apparatus for a vehicle, a vehicle with the display apparatus and a method of controlling the display apparatus.

2. Description of the Related Art

In general, a vehicle is a machine which travels on roads or tracks to carry people, objects or animals from place to place. Such a vehicle may include a three-wheeled or four-wheeled car, a two-wheeled vehicle such as a motorcycle, construction equipment, a motorized bicycle, a bicycle, a train and the like.

Recently, many kinds of display apparatuses are installed to a vehicle in order to provide a driver or a passenger with information such as a traveling route or a traveling state. In particular, a display apparatus may provide a driver or a passenger with information related to a route to a destination from a start location, information related to a traveling vehicle, such as a present position of a vehicle or a traveling speed, and information required to drive a vehicle, such as a traveling time, a traveling distance, a fuel efficiency or a residual fuel quantity. Such a display apparatus may be installed to a gauge panel, a dashboard or the like so as to provide traveling speed information, trip information, route information or the like.

### SUMMARY

It is an aspect of the present invention to provide a display apparatus for a vehicle enabling a user, i.e., a driver or a passenger, to easily obtain required information during traveling of a vehicle by providing the information effectively and efficiently.

It is another aspect of the present invention to provide a vehicle equipped with the above display apparatus.

It is a further aspect of the present invention to provide a method of controlling the above display apparatus.

Additional aspects of the invention will be set forth in part in the description which follows and, in part, will be obvious from the description, or may be learned by practice of the invention.

In accordance with one aspect of the present invention, a display apparatus for a vehicle comprises: a display unit including a plurality of display regions to respectively display information thereon; and an input unit configured to receive a selection command to select one of the display regions, wherein the display region selected according to the selection command is expanded to display detailed information, and the display region other than the selected display region displays brief information.

The display regions may be arranged in sequence from top to bottom.

The selected display region may be expanded by increase in height thereof according to the selection command, and the display region other than the selected display region may be contracted by decrease in height thereof according to the selection command.

The selection command may include an upper region selection command or a lower region selection command.

If the upper region selection command is input, a display region arranged above a previously selected display region may be expanded to display detailed information according to the upper region selection command, and the previously selected display region may be contracted to display brief information.

The display regions may be configured to display at least one of information related to future traveling of a vehicle, information related to a present traveling state of a vehicle, and information related to past traveling of a vehicle.

The display regions may further display information related to vehicle inspection and user settings.

The input unit may be configured to receive a detailed information change command, and the detailed information displayed on the selected display region may be changed according to the detailed information change command.

The input unit may include at least one of a scroll wheel, a button, a knob, a touchscreen, a touch pad, a lever, a trackball, a motion sensor and a voice recognition sensor.

In accordance with another aspect of the present invention, a vehicle comprises: a display unit including a plurality of display regions; and an input unit configured to receive a selection command to select one of the display regions, wherein the display region selected according to the selection command is expanded to display detailed information, and the display region other than the selected display region displays brief information.

The input unit may be mounted to at least one of a steering wheel, a dashboard, a center fascia, a gearbox and a console box.

The display unit may be mounted to at least one of a gauge panel, a center fascia and a console box.

In accordance with a further aspect of the present invention, a method of controlling a display apparatus for a vehicle comprises: receiving a selection command to select one of a plurality of display regions; and displaying detailed information on the selected display region, the selected display region being expanded according to the selection command, and brief information on the other display region, the other display region being contracted according to the selection command.

The display regions may be arranged in sequence from top to bottom.

The displaying may include increasing the selected display region in height according to the selection command and decreasing the other display region in height according to the selection command.

The selection command may include an upper region selection command or a lower region selection command.

The displaying may include displaying detailed information on a display region arranged above a previously selected display region according to the upper region selection command, the display region arranged above the previously selected display region being expanded, and displaying brief information on the previously selected display region according to the upper region selection command, the previously selected display region being contracted.

The display regions may display at least one of information related to future traveling of a vehicle, information related to a present traveling state of a vehicle, and information related to past traveling of a vehicle.

The method may further comprise: receiving a detailed information change command; and changing the detailed information displayed on the selected display region according to the detailed information change command.

The method may further comprise: operating a display apparatus for a vehicle; and displaying detailed information on one of the display regions, the one display region being expanded according to predetermined settings, and brief information on the other display region, the other display region being contracted according to predetermined settings.

According to the display apparatus for a vehicle, the vehicle with the display apparatus and the method of controlling the display apparatus of the present invention, since a variety of information is provided effectively and efficiently for a user during traveling of a vehicle, a user may obtain required information easily, conveniently and rapidly.

Further, since some information related to a vehicle and traveling is selected to be displayed in detail and other information is selected to be displayed briefly, a user may obtain a desired amount of information according to his or her needs.

In addition, since the display apparatus displays the screen with little change of layout of the screen and great consistency, a user may obtain required information rapidly without confusion during traveling of a vehicle.

Further, a user may obtain a variety of information intuitively with simple manipulation.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a constitutional view of an exemplary embodiment of a display apparatus for a vehicle;

FIG. 2 is a view of an exemplary embodiment of an interior of a vehicle;

FIG. 3 is a view of a scroll wheel manipulation device which is a first embodiment of an input unit;

FIG. 4 is a view of a button manipulation device which is a second embodiment of an input unit;

FIG. 5 is a view illustrating a first embodiment of a display unit for a vehicle;

FIG. 6 is a view illustrating a second embodiment of a display unit for a vehicle;

FIG. 7 is a view illustrating a first example of a screen displayed on a display apparatus for a vehicle;

FIG. 8 is a view illustrating a second example of a screen displayed on a display apparatus for a vehicle;

FIG. 9 is a view illustrating a third example of a screen displayed on a display apparatus for a vehicle;

FIG. 10 is a view illustrating a fourth example of a screen displayed on a display apparatus for a vehicle;

FIG. 11 is a view illustrating a fifth example of a screen displayed on a display apparatus for a vehicle;

FIG. 12 is a view illustrating a sixth example of a screen displayed on a display apparatus for a vehicle;

FIG. 13 is a view illustrating a seventh example of a screen displayed on a display apparatus for a vehicle;

FIG. 14 is a view illustrating an eighth example of a screen displayed on a display apparatus for a vehicle;

FIG. 15 is a view illustrating a ninth example of a screen displayed on a display apparatus for a vehicle;

FIG. 16 is a view illustrating a tenth example of a screen displayed on a display apparatus for a vehicle; and

FIG. 17 is a flowchart illustrating an exemplary embodiment of a method of controlling a display apparatus for a vehicle.

### DETAILED DESCRIPTION

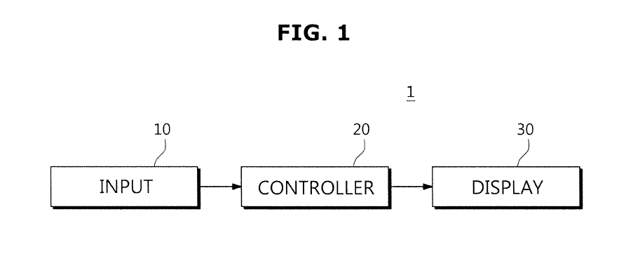

Hereinafter, preferred embodiments of a display apparatus for a vehicle, a vehicle with the display apparatus and a method of controlling the display apparatus will be described with reference to FIGS. 1 through 17.

FIG. 1 is a constitutional view of an exemplary embodiment of a display apparatus for a vehicle. As shown in FIG. 1, a display apparatus 1 for a vehicle may comprise an input unit 10 to output an electrical input signal corresponding to user manipulation, a control unit 20 to receive the input signal transmitted from the input unit 10 and generate an electrical control signal corresponding to the input signal transmitted thereto, and a display unit 30 to display an image corresponding to the control signal from the control unit 20.

In particular, the input signal from the input unit 10 may include a selection command to allow a user to select at least one display region from a plurality of display regions displayed on the display unit 30. The control unit 20 may generate a control command according to the selection command output from the input unit 10 and transmit the generated control command to the display unit 30. The display unit 30 may display detailed information on the display region selected according to the control command by expanding the selected display region. In addition, the display unit 30 may display brief information on the display region other than the selected display region, i.e., the non-selected display region, by contracting the non-selected display region.

The input unit 10, the control unit 20 and the display unit 30 may exchange electrical signals, such as a selection command or a control command, by wired electrical connection using cables or circuits or by wireless electrical connection using a wireless communication network such as a controller area network (CAN).

The input unit 10 may be embodied by at least one or a combination of the following devices: a scroll wheel, a button, a knob, a touchscreen, a touch pad, a lever, a trackball, a motion sensor and a voice recognition sensor. The control unit 20 may be embodied by a processing device such as a microprocessor including semiconductor chips capable of operating or executing a command. The display unit 30 may be embodied by a display device adopting a liquid crystal display (LCD) panel, a light emitting diode (LED) panel, an organic light emitting diode (OLEO) panel, a plasma display panel (PDP) or the like. A liquid crystal display may include a thin film transistor-LCD (TFT-LCD). According to circumstance, the input unit 10 and the display unit 30 may be integrally embodied by a touchscreen panel (TSP).

The input unit 10 may be disposed at a steering wheel, a center fascia, a gearbox, a console box or other devices installed to a vehicle. The display unit 30 may be disposed at a gauge panel, a dashboard, a center fascia, a console box or other devices of a vehicle.

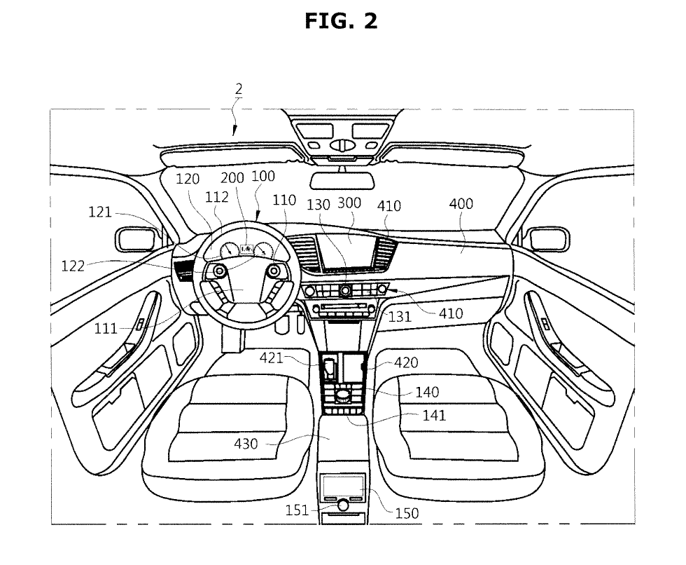

FIG. 2 is a view of an exemplary embodiment of an interior of a vehicle.

Referring to FIG. 2, the interior of a vehicle 2 may be provided with a dashboard 400, a center fascia 410 extended from the dashboard 400, a gearbox 420 arranged below the center fascia 410, and a console box 430 arranged behind the gearbox 420.

The dashboard 400 serves to separate the interior of the vehicle 2 from an engine room 5. A steering wheel 100, a gauge panel 120 and a ventilation hole 401 may be mounted to the dashboard 400.

The steering wheel 100 may be arranged at an area of the dashboard 400 near a driver's seat. The steering wheel 100 may include a rim 112 grasped by a driver and a spoke 111 connecting the rim 112 to a hub of a steering device positioned on a steering axle. A driver rotates the spoke 111 by manipulating the rim 112 to change a moving direction of wheels, thereby steering the vehicle 2. The spoke 111 may be provided with a first input unit 110 to control a radio device, a vehicle communication device or the gauge panel 120. For example, as shown in FIG. 2, the spoke 111 may be provided with the first input unit 110 which is embodied by a scroll wheel, a button, a knob, a touchscreen, a touch pad, a lever, a trackball, a motion sensor or a voice recognition sensor. The first input unit 110 may also include any other input device that may be considered by those skilled in the art. A driver may adjust a display region or change information displayed on a first display unit 200 by manipulating the first input unit 110.

The gauge panel 120 may display a traveling speed, the number of revolutions per minute of an engine, a residual fuel quantity and the like. The gauge panel 120 may be typically arranged at the dashboard 400 behind the steering wheel 100. According to circumstance, the gauge panel 120 may be arranged at other positions of the dashboard 400 or the center fascia 410. As shown in FIG. 2, the gauge panel 120 may include a speedometer 121 indicating a traveling speed, a tachometer 122 indicating the number of revolutions per minute of an engine, and a fuel gauge indicating a residual fuel quantity.

According to an exemplary embodiment, the gauge panel 120 may include a first display unit 200 to provide a user with a variety of information. The first display unit 200 may be arranged between the speedometer 121 and the tachometer 122. The first display unit 200 may display information related to future traveling, present traveling and past traveling. For example, the first display unit 200 may display information related to a present vehicle traveling state, such as a distance to empty, an average fuel efficiency, an instantaneous fuel efficiency, a traveling distance, a traveling time, an average speed, a highest speed, navigation information, a distance to a destination, an estimated time of arrival, a toll, a cruise speed and the like, and information or warnings related to maintenance of the vehicle.

According to an exemplary embodiment, the first display unit 200 may display a variety of information on a plurality of display regions. In this case, the display regions may be changed in size according to user manipulation or a preset program. The respective display regions may display different information. For example, one of the display regions may display information related to a future traveling state of the vehicle, such as an intended route or a distance to a destination, another one of the display regions may display information related to a present traveling state of the vehicle, such as a current setting state, and yet another one of the display regions may display information related to a past traveling state of the vehicle, such as various accumulated traveling records. Further, some display regions may display detailed information, and the other display regions may display brief information. Herein, the brief information refers to a part of information selected from the detailed information for user reference. In this case, the detailed information may be displayed on an expanded display region, and the brief information may be displayed on a contracted display region.

The ventilation hole 401 serves to adjust a temperature in the vehicle 2 by supplying air of a certain temperature into the vehicle 2 according to operation of an air conditioning device. The ventilation hole 401 may be provided in plural and arranged at diverse positions of the dashboard 400. For example, as shown in FIG. 2, the ventilation holes 401 may be arranged near both lateral surfaces of a second display unit 300.

The second display unit 300 may be mounted to an upper frame of the dashboard 400. The second display unit 300 may output various images including moving images and static images to a user. The second display unit 300 may display information required to drive the vehicle as images. For example, the second display unit 300 may display a map around the vehicle or a traveling route. The second display unit 300 may be configured as a navigation system.

The center fascia 410 may be positioned between the dashboard 400 and the gearbox 420. The center fascia 410 may be provided with second input units 130 and 131 through which a user, i.e., a driver or a passenger, inputs commands to operate various functions of the vehicle 2. The second input units 130 and 131 may include at least one of a scroll wheel, a button, a knob, a touchscreen, a touch pad, a lever and a trackball. The second input units 130 and 131 may also include any other input device that may be considered by those skilled in the art. A user may adjust the display region or change information displayed on the first display unit 200 by manipulating the second input units 130 and 131.

The gearbox 420 containing a gear device therein may be disposed below the center fascia 410. A gear stick 421 for gear shift may protrude from the gearbox 420. The gearbox 420 may be provided with third input units 140 and 141 through which a driver inputs commands to operate various functions of the vehicle 2. The third input units 140 and 141 may include at least one of a knob, a button, a joystick, a lever, a trackball, a manipulation wheel, a motion sensor, a recognition sensor and a touch sensor. The third input units 140 and 141 may also include any other input device that may be considered by those skilled in the art. A driver or a passenger may adjust the display region or change information displayed on the first through third display units 200, 300 and 150 by manipulating the third input units 140 and 141.

The console box 430 may be arranged behind the gearbox 420. The console box 430 may have a predetermined inner space to store items therein. A third display unit 150 to display an image to a passenger on a rear seat or a fourth input unit 151 manipulated by a passenger on a rear seat may be provided at an outer surface of the console box 430.

The first through third display units 200, 300 and 150 may be controlled by manipulation of the first through fourth input units 110, 130, 140 and 151. In this case, one of the input units, e.g., the first input unit 110 may be configured to control all of the display units 200, 300 and 150. The first through third display units 200, 300 and 150 may display the same screen or display different screens.

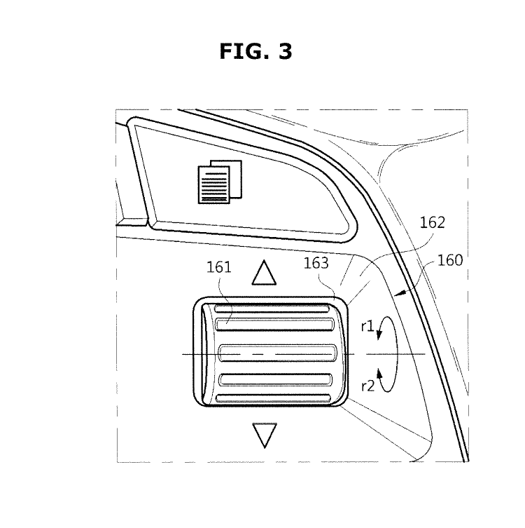

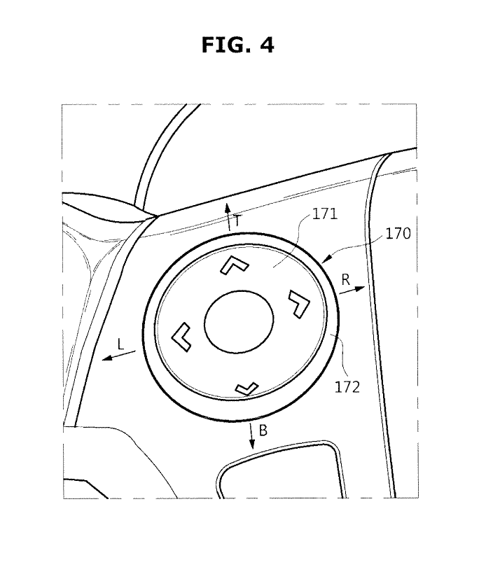

Hereinafter, various examples of the first input unit 110 mounted to the spoke 111 of the steering wheel 100 will be explained with reference to FIGS. 3 and 4. However, the examples described below are not limited to the first input unit 110. According to circumstance, the examples of the first input unit 110 described below may also be applied to the second through fourth input units 130, 131, 140, 141 and 151. The mounting position of the first input unit 110 is not limited to the spoke 111 of the steering wheel 100. For example, the first input unit 110 may be mounted to the rim 112 of the steering wheel 100.

FIG. 3 is a view of a scroll wheel manipulation device which is a first embodiment of the input unit. Referring to FIG. 3, a scroll wheel manipulation device 160 may include a scroll wheel 161 and a scroll wheel housing 162 having a hole 163 through which the scroll wheel 161 is exposed to the outside. The scroll wheel housing 162 may be a part of the housing to which the scroll wheel manipulation device 160 is mounted, e.g., a part of the housing forming the spoke 111. The scroll wheel 161 may be rotated in an upward direction r1 or downward direction r2 according to user manipulation. When the scroll wheel 161 is rotated in the upward direction r1 or downward direction r2, the scroll wheel manipulation device 160 may output an electrical signal corresponding to the rotating direction r1 or r2. The output signal may be transmitted to the control unit 20 directly or indirectly via other components such as an amplifier. The control unit 20 may include a microprocessor of a printed circuit board provided in the dashboard 400 or the center fascia 410. The control unit 20 may generate a control command corresponding to the signal transmitted thereto and transmit the control command to at least one of the first through third display units 200, 300 and 150. According to an exemplary embodiment, the control command generated from the control unit 20 may be an upper region selection command or a lower region selection command. The upper region selection command may be a selection command corresponding to the electrical signal output according to rotation of the scroll wheel 161 in the upward direction r1, and the lower region selection command may be a selection command corresponding to the electrical signal output according to rotation of the scroll wheel 161 in the downward direction r2. In this way, a driver may select an upper region arranged above the currently-expanded display region or a lower region arranged below the currently-expanded display region. According to an exemplary embodiment, a user may also input a command by pressing the scroll wheel 161 of the scroll wheel manipulation device 160 just like pressing a typical button. If the scroll wheel 161 is pressed by a user, the scroll wheel 161 may output a corresponding electrical signal. The control unit 20 may generate a detailed information change command according to manipulation of an auxiliary button 164 to make the display region display new information, and may transmit the detailed information change command to the first through third display units 200, 300 and 150. The scroll wheel manipulation device 160 may further include one or more auxiliary buttons to output electrical signals corresponding to user manipulation. By pressing the auxiliary buttons, a user may input the same command as when pressing the scroll wheel 161.

FIG. 4 is a view of a button manipulation device which is a second embodiment of the input unit. Referring to FIG. 4, a button manipulation device 170 may include a button 171 and a button housing 172 to which the button 171 is mounted. Similar to the above description, the button housing 172 may be a part of the housing to which the button manipulation device 170 is mounted, e.g., a part of the housing forming the spoke 111. By pressing the whole or a part of the button manipulation device 170, a user, e.g., a driver may select at least one direction of an upward direction T, a downward direction B. a right direction R and a left direction L. The button manipulation device 170 may output an electrical signal corresponding to the selected direction, and the signal output from the button manipulation device 170 may be transmitted to the control unit 20. The control unit 20 may generate a control command corresponding to the signal transmitted thereto and transmit the control command to at least one of the first through third display units 200, 300 and 150. According to an exemplary embodiment, the control command generated from the control unit 20 may correspond to an upper region selection command, a lower region selection command or a detailed information change command. Herein, the upper region selection command may correspond to the electrical signal according to selection of the upward direction T, and the lower region selection command may correspond to the electrical signal according to selection of the downward direction B. The detailed information change command may correspond to the electrical signal according to selection of the right direction R and/or the left direction L.

Although the examples of the first input unit 110 have been described above, the first input unit 110 is not limited to the above-described constitution. For example, the first input unit 110 may include at least one or a combination of the following devices: a knob, a touchscreen, a touch pad and a trackball. The first input unit 110 may be configured to receive a certain instruction or command from a user by user manipulation or even without user manipulation as necessary. For example, the first input unit 110 may be a motion sensor or a voice recognition sensor. In this case, a user may input a certain instruction or command by making a gesture at the motion sensor or speaking aloud.

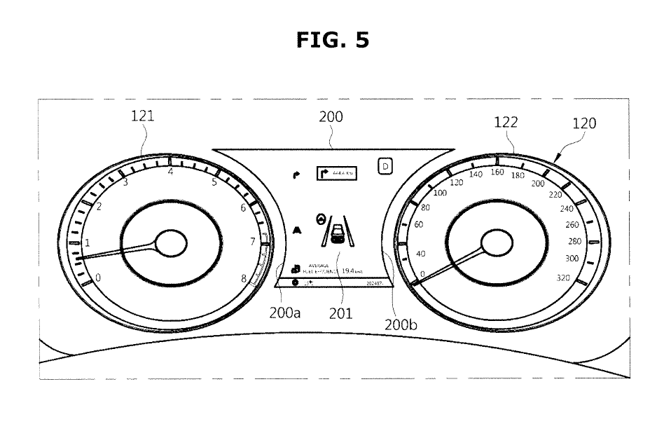

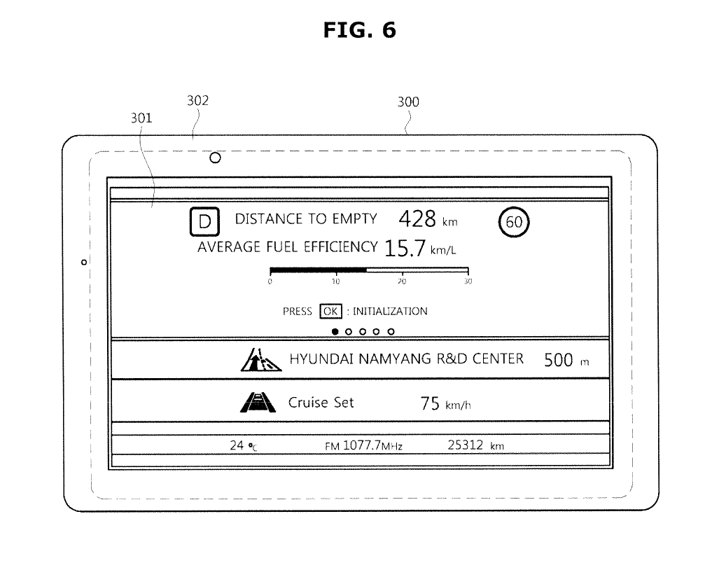

Hereinafter, various examples of the display unit will be described with reference to FIGS. 5 and 6.

FIG. 5 is a view illustrating a first embodiment of the display unit for a vehicle. Referring to FIG. 5, the first display unit 200 may be provided at the gauge panel 120 and arranged between the speedometer 121 and the tachometer 122. However, the position of the first display unit 200 is not limited to a position between the speedometer 121 and the tachometer 122. For example, the first display unit 200 may be arranged above or below the speedometer 121 or the tachometer 122. The first display unit 200 may also be arranged at any other place that may be considered from a point of view of convenience in use or design. As shown in FIG. 5, the first display unit 200 may have curved lateral surfaces 200a and 200b corresponding to the shape of the speedometer 121 and the tachometer 122, however, the shape of the first display unit 200 is not limited thereto. The first display unit 200 may have a square shape, a rectangular shape, a diamond shape, a trapezoidal shape, a circular shape, an elliptical shape or the like according to a system designer's choice. The first display unit 200 may display a predetermined screen 201.

FIG. 6 is a view illustrating a second embodiment of the display unit for a vehicle. Referring to FIG. 6, the second display unit 300 may include a display panel 301 and an exterior housing 302 to fix the display panel 301. The exterior housing 302 may have a securing means (not shown) mounted to lateral surfaces or a rear surface thereof to be secured to a predetermined position in the vehicle 2, e.g., the dashboard 400. As shown in FIG. 6, in the case in which the second display unit 300 is provided at an upper end portion of the dashboard 400, since the second display unit 300 may be mounted to various positions in the vehicle 2, a passenger as well as a driver may check the contents on the screen.

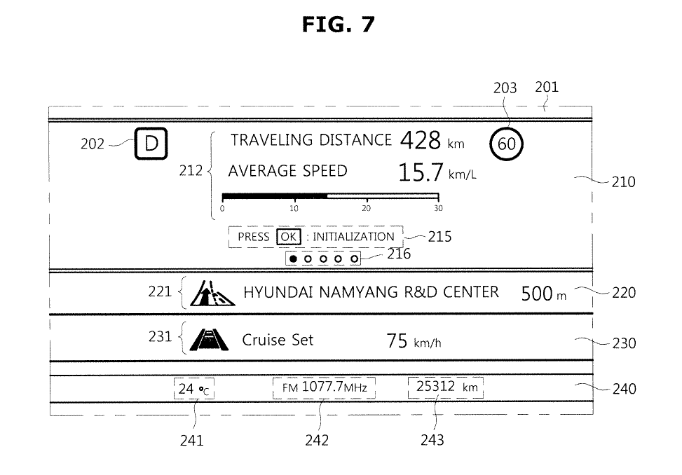

Hereinafter, examples of a screen to be displayed on the display unit of the display apparatus will be described with reference to FIGS. 7 through 16. For convenience of explanation, examples of the screen displayed on the first display unit 200 depicted in FIGS. 2 and 5 will be explained. However, the examples of the screen explained below with reference to FIGS. 7 through 16 are not limited to the screens displayed on the first display unit 200. For example, the screens explained below may be screens displayed on the second display unit 300 depicted in FIGS. 2 and 6 or screens displayed on the third display unit 150 depicted in FIG. 2. The input unit manipulated by a user to control the screen may be at least one of the first through fourth input units 110, 130, 131, 140, 141 and 151.

FIG. 7 is a view illustrating a first example of a screen displayed on the display apparatus for a vehicle. Referring to FIG. 7, a screen 201 of the display unit 200 may include a plurality of display regions 210, 220 and 230 to respectively display information thereon. According to an exemplary embodiment, as shown in FIG. 7, the respective display regions 210, 220 and 230 may be arranged in sequence from top to bottom. According to another exemplary embodiment, the respective display regions may be arranged in sequence from left to right. The screen 201 may further include an additional information display region 240 to provide a variety of information. The additional information display region 240 may display additional information which is not provided by the display regions 210, 220 and 230, e.g., an external temperature 241, a selected radio broadcast frequency 242 and a cumulative travelling distance 243. The screen 201 may display fixed signs 202 and 203. The fixed signs 202 and 203 may refer to signs that continuously indicate information without change although the display regions 210, 220 and 230 are changed in size. The fixed signs 202 and 203 may indicate information that a driver should always check, e.g., a gear position 202 and a traveling speed 203.

The respective display regions 210, 220 and 230 may display different information. For example, information related to past traveling may be displayed on the first display region 210, information related to future traveling may be displayed on the second display region 220, and information related to a present traveling state may be displayed on the third display region 230. In particular, information that is estimated, accumulated or calculated as the vehicle travels may be displayed on the first display region 210. For example, information on a traveling distance, a traveling time, an average traveling speed, an average fuel efficiency or an instantaneous fuel efficiency may be displayed on the first display region 210. Such information may be information that is estimated, accumulated or calculated since a trip meter was reset. Navigation information, such as route search and search results, may be displayed on the second display region 220. Herein, turn-by-turn (TBT) navigation information may be displayed on the second display region 220. In this case, the turn-by-turn navigation information may include a next turn, a distance to a destination, an estimated time of arrival, a toll, and a road category such as a highway, an overpass, an underpass and the like. Information related to present traveling, e.g., cruise traveling and change settings menu, may be displayed on the third display region 230. For example, the third display region 230 may display a cruise set, a cruise speed, a safe distance between cars, a lane departure warning message, a steering operation message, a speed limit, an automatic speed control message and the like. Further, the third display region 230 may display a menu to set values related to cruise traveling, e.g., a cruise speed and a safe distance between cars. Although examples of information displayed on the display regions 210, 220 and 230 have been described above, the information displayed on the display regions 210, 220 and 230 is not limited to the aforementioned information. For example, information related to future traveling may be displayed on the first display region 210, information related to a present traveling state may be displayed on the second display region 220, and information related to past traveling may be displayed on the third display region 230. A variety of information that may be considered by a system designer may also be displayed on the display regions 210, 220 and 230. In addition, the information displayed on the display regions 210, 220 and 230 may be changed according to user selection. For example, a user may change the configuration such that the information preset to be displayed on the first display region 210 is displayed on the second display region 220 and the information preset to be displayed on the second display region 220 is displayed on the first display region 210.

The display regions 210, 220 and 230 may not have the same size. For example, as shown in FIG. 7, the first display region 210 may have a larger size than the second display region 220 and the third display region 230. The second display region 220 and the third display region 230 may have the same size. In this case, the first display region 210 having a relatively large area may be configured to display detailed information 212, and the second and third display regions 220 and 230 having a relatively small area may be configured to display brief information 221 and 231. For example, the first display region 210 may display a variety of information, such as a distance to empty, an average fuel efficiency and an average fuel efficiency graph, and the second display region 220 may display brief information, e.g., only the next turn. According to circumstance, the first display region 210 having a relatively large area may further display a guidance message 215 and a sign 216 to guide change or initialization of information displayed on the first display region 210. The sign 216, as shown in FIG. 7, may include a plurality of dots corresponding to the number of browsable pages.

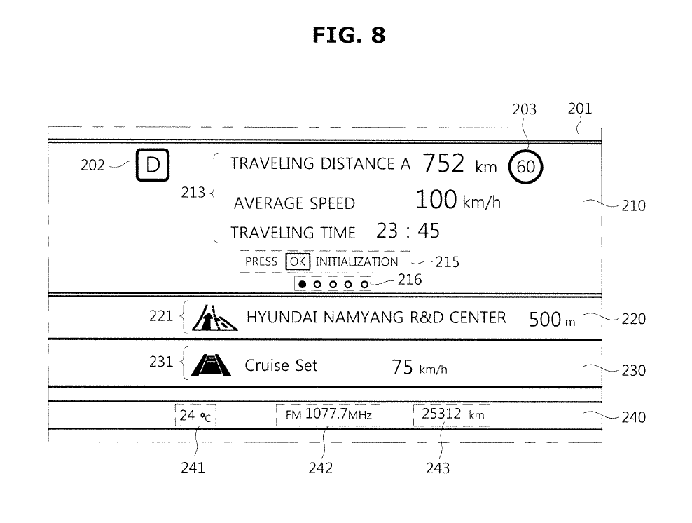

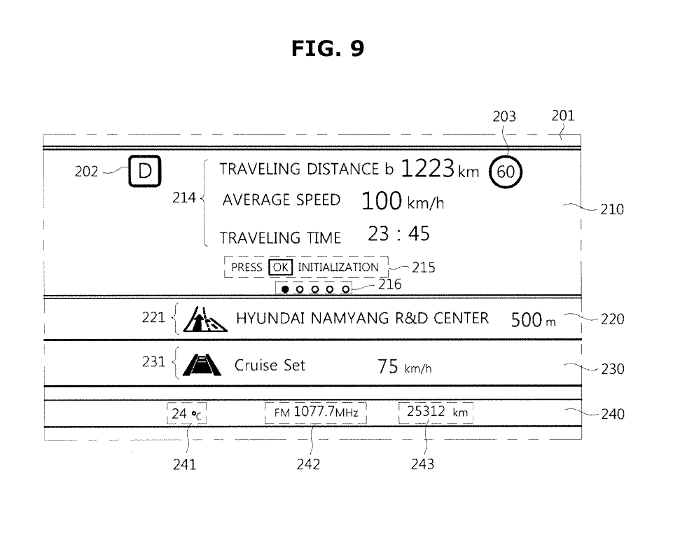

FIG. 8 is a view illustrating a second example of a screen displayed on the display apparatus for a vehicle, and FIG. 9 is a view illustrating a third example of a screen displayed on the display apparatus for a vehicle. If a driver presses the scroll wheel 161 of the scroll wheel manipulation device 160, a left or right portion of the button 171 of the button manipulation device 170, or the lever 181 of the lever manipulation device 180 in the left or right direction, the control unit 20 may output a detailed information change command according to user manipulation and transmit the command to the display unit 200. According to the detailed information change command, as shown in FIGS. 8 and 9, the first display region 210 of the display unit 200 may display new detailed information 213 and 214 which is different from the previous information 212. The new detailed information 213 and 214 may include a traveling distance, an average speed and a traveling time as shown in FIG. 8, or a traveling distance, an average speed and a traveling time calculated since a trip meter was reset as shown in FIG. 9.

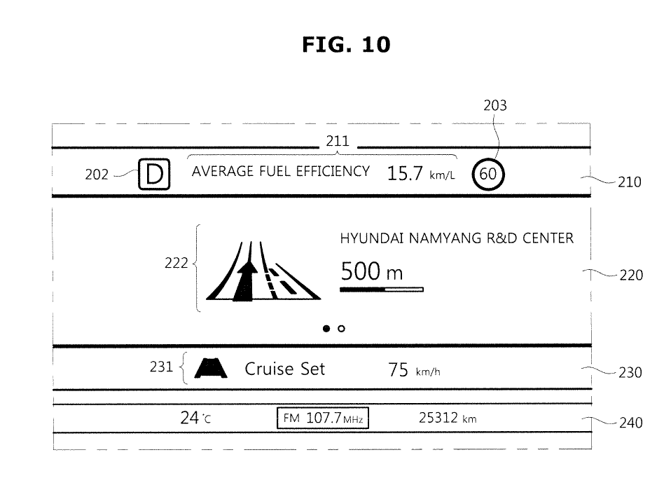

FIG. 10 is a view illustrating a fourth example of a screen displayed on the display apparatus for a vehicle. The display regions 210, 220 and 230 may be expanded or contracted in size as necessary. In this case, while a specific display region is expanded, the display regions other than the specific display region may be contracted or maintained in size. If the display region other than the specific display region has been a relatively large display region before change, the display region other than the specific display region may be contracted in size. If the display region other than the specific display region has been a relatively small display region before change, the display region other than the specific display region may be maintained in size. For example, when the first display region 210 is larger than the second and third display regions 220 and 230 as shown in FIG. 7, according to user manipulation or predetermined settings, the first display region 210 may be contracted in size, the second display region 220 may be expanded in size, and the third display region 230 may be maintained in size as shown in FIG. 10. When the first through third display regions 210, 220 and 230 are arranged in sequence from top to bottom as shown in FIGS. 7 through 10, the second display region 220 arranged below the first display region 210 may be expanded by increase in height, and the first display region 210 may be contracted by decrease in height. When the display regions are arranged in sequence from left to right, the specific display region may be expanded by increase in width, and the other display region may be contracted by decrease in width. In this case, the newly expanded second display region 220 may display detailed information 222 such as a turn-by-turn navigation image, a destination, and a distance to the next event on the route, and the contracted first display region 210 may display brief information 211 such as an average fuel efficiency.

According to an exemplary embodiment, the change in size of the display regions 210, 220 and 230 may be achieved by predetermined settings. For example, when the event, such as change of the route or the next turn, happens, the second display region 220 displaying the navigation information may be expanded, and the first display region 210 which has been the largest region before expansion of the second display region 220 may be contracted, thereby displaying information necessary to a driver in more detail.

According to an exemplary embodiment, the change in size of the display regions 210, 220 and 230 may be achieved by user manipulation. For example, when a driver rotates the scroll wheel 161 in the upward direction r1 or downward direction r2 and accordingly the control unit 20 outputs an upper region selection command or a lower region selection command, any one of the display regions 210, 220 and 230 may be selected and expanded according to the output selection command. When the first display region 210 is in an expanded state as shown in FIG. 7, if the upper region selection command is output, the display region arranged above the first display region 210 may be expanded. If no display region exists above the first display region 210, the display region arranged at the bottom, e.g., the third display region 230, may be expanded, and the first display region 210 may be contracted. According to circumstance, the upper region selection command may be cancelled. When the first display region 210 is in an expanded state as shown in FIG. 7, if the lower region selection command is output, the second display region 220 arranged below the first display region 210 may be expanded, and the first display region 210 may be contracted. By pressing an upper or lower portion of the button 171 of the button manipulation device 170 or the lever 181 of the lever manipulation device 180 in the upward or downward direction, a driver may also select the upper region or the lower region.

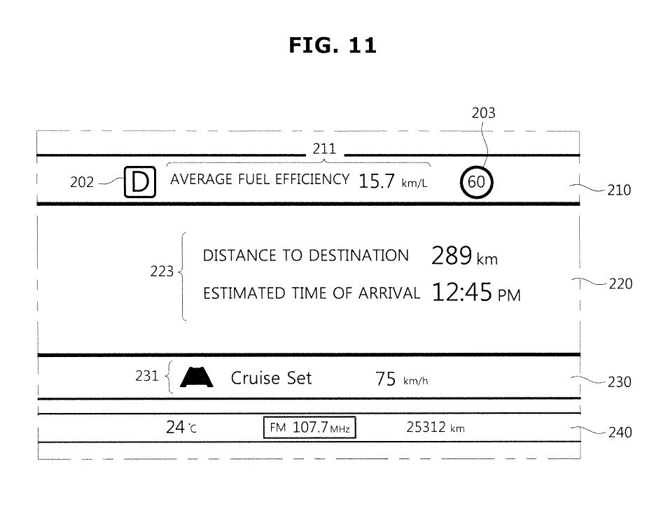

FIG. 11 is a view illustrating a fifth example of a screen displayed on the display apparatus for a vehicle. Similar to the above description, when the second display region 220 is in an expanded state, if a driver presses the auxiliary button 164 of the scroll wheel manipulation device 160, a left or right portion of the button 171 of the button manipulation device 170, or the lever 181 of the lever manipulation device 180 in the left or right direction, as shown in FIG. 11, the second display region 220 of the display unit 200 may display new detailed information 223 which is different from the previous information 222. The new detailed information 223 may include a distance to a destination or an estimated time of arrival.

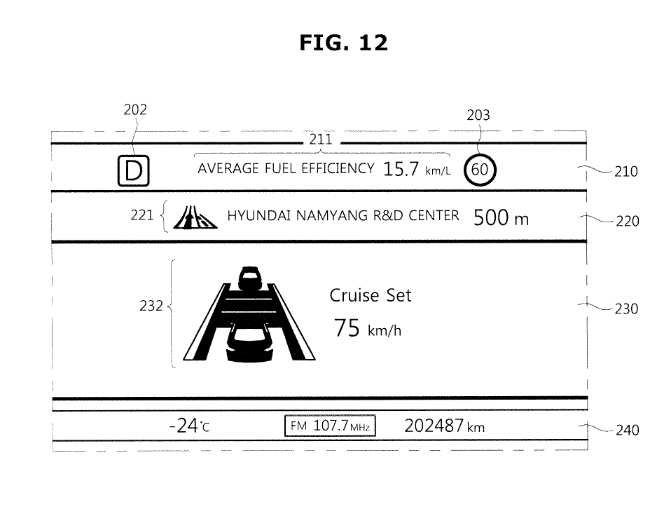

FIG. 12 is a view illustrating a sixth example of a screen displayed on the display apparatus for a vehicle. When the second display region 220 is expanded and displays detailed information as shown in FIGS. 10 and 11, if a driver selects the lower region by rotating the scroll wheel 161 in the downward direction r2 or detailed information needs to be displayed on the third display region 230 according to predetermined settings, the third display region 230 may be expanded and the second display region 220 may be contracted as shown in FIG. 12. Similar to the above description, the detailed information 232 may be displayed on the third display region 230, and the brief information 221 may be displayed on the second display region 220. In this case, the detailed information 232 displayed on the third display region 230 may include cruise traveling or settings related to the cruise traveling.

Conversely, if a driver selects the upper region by rotating the scroll wheel 161 in the upward direction r1 or detailed information needs to be displayed on the first display region 210 according to predetermined settings, the first display region 210 may be expanded and the second display region 220 may be contracted as shown in FIG. 7. In this case, similar to the above description, the detailed information 212 may be displayed on the first display region 210, and the brief information 221 may be displayed on the second display region 220.

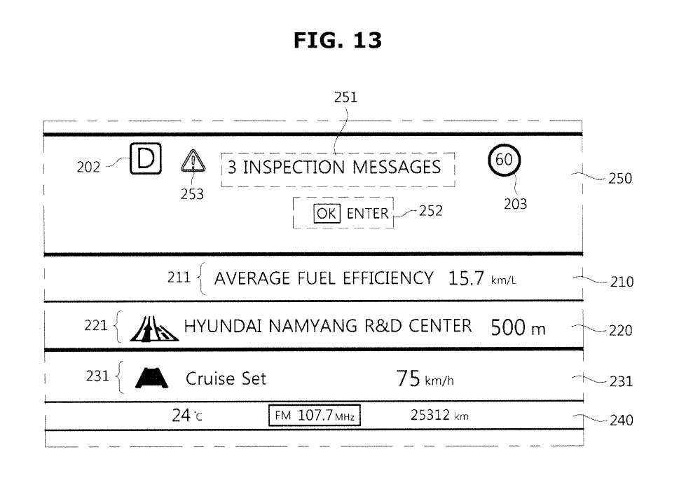

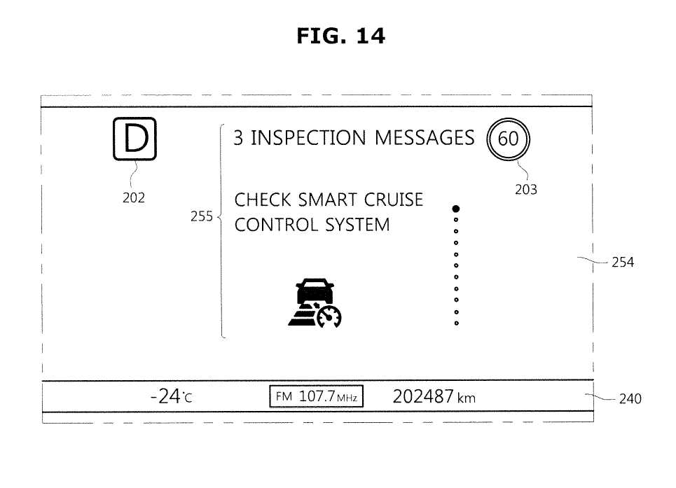

FIG. 13 is a view illustrating a seventh example of a screen displayed on the display apparatus for a vehicle, and FIG. 14 is a view illustrating an eighth example of a screen displayed on the display apparatus for a vehicle. In addition to the above-described first through third display regions 210, 220 and 230, the screen 201 of the display unit 200 may further include a fourth display region 250. As shown in FIG. 13, the fourth display region 250 may be arranged above the first display region 210. However, the fourth display region 250 may also be arranged between any two arbitrary display regions of the first through third display regions 210, 220 and 230 or arranged below the third display region 230. If not selected by a user, the fourth display region 250 may not be shown on the screen 201 or may be maintained in a contracted state. According to predetermined settings, the fourth display region 250 may also not be shown on the screen 201 or may be maintained in a contracted state. If a driver selects the fourth display region 250 by manipulating the scroll wheel 161 or the information displayed on the fourth display region 250 needs to be provided for a user according to predetermined settings, as shown in FIG. 13, the fourth display region 250 may be expanded to display detailed information, and the first through third display regions 210, 220 and 230 may be contracted to display the brief information 211, 221 and 231. The detailed information displayed on the fourth display region 250 may be inspection information. The inspection information may include a warning message 251 related to traveling or parts of the vehicle, a guidance message 252 for conduct to be performed by a user, and various signs 253. The warning message 251 may include messages related to emergency, such as an improper tire pressure, a lack of washing fluid or engine oil, a lack of battery capacity, engine overheating, malfunction of lamps or auxiliary systems and the like. If a user manipulates a button according to the guidance message 252, as shown in FIG. 14, a message 255 indicating emergency may be displayed on a separate screen 254. In this case, the fixed signs 202 and 203 may be still displayed on the screen 201.

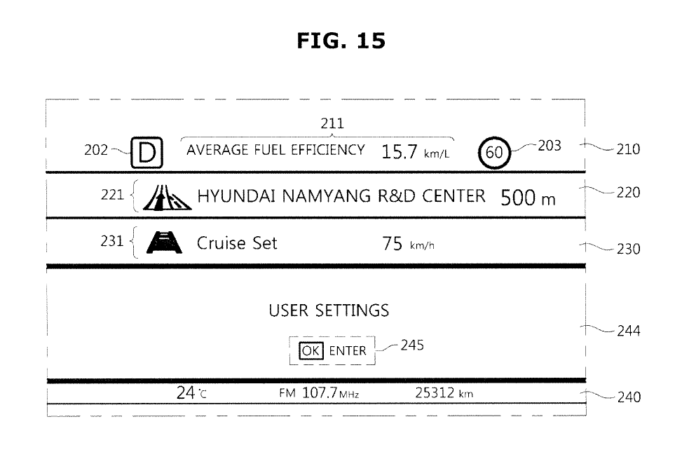

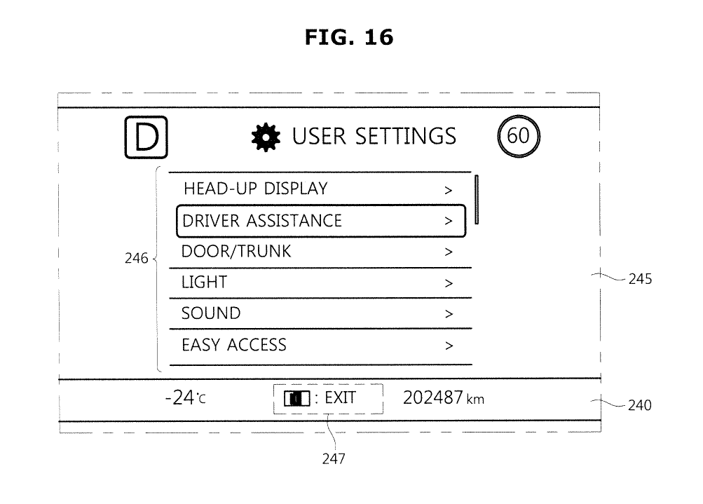

FIG. 15 is a view illustrating a ninth example of a screen displayed on the display apparatus for a vehicle, and FIG. 16 is a view illustrating a tenth example of a screen displayed on the display apparatus for a vehicle. In the state in which the third display region 230 is selected and expanded to display the detailed information as shown in FIG. 12, if a driver selects the lower region by rotating the scroll wheel 161 in the downward direction r2 or a user setting screen needs to be displayed according to predetermined settings, a fifth display region 244 may be shown or expanded as shown in FIG. 15. When a user does not select the fifth display region 244 or the fifth display region 244 does not need to be shown, the fifth display region 244 may not be shown on the screen 201 or may be maintained in a contracted state. Information related to user settings for conduct to be performed by a user may be displayed on the fifth display region 244. The information related to user settings may include a setting screen display guidance message 245 to enter a setting screen or various menus 246 related to settings. In the case in which the setting screen display guidance message 245 is displayed as shown in FIG. 15, if a user manipulates the button according to the setting screen display guidance message 245, a separate setting screen 245 including the various menus 246 may be displayed as shown in FIG. 16. In addition, in this case, the fixed signs 202 and 203 may be displayed on the screen 201. A user may change settings related to the functions of the vehicle through the setting screen 245. As necessary, the separate setting screen 245 may further display a guidance sign 247 to exit the setting screen 245.

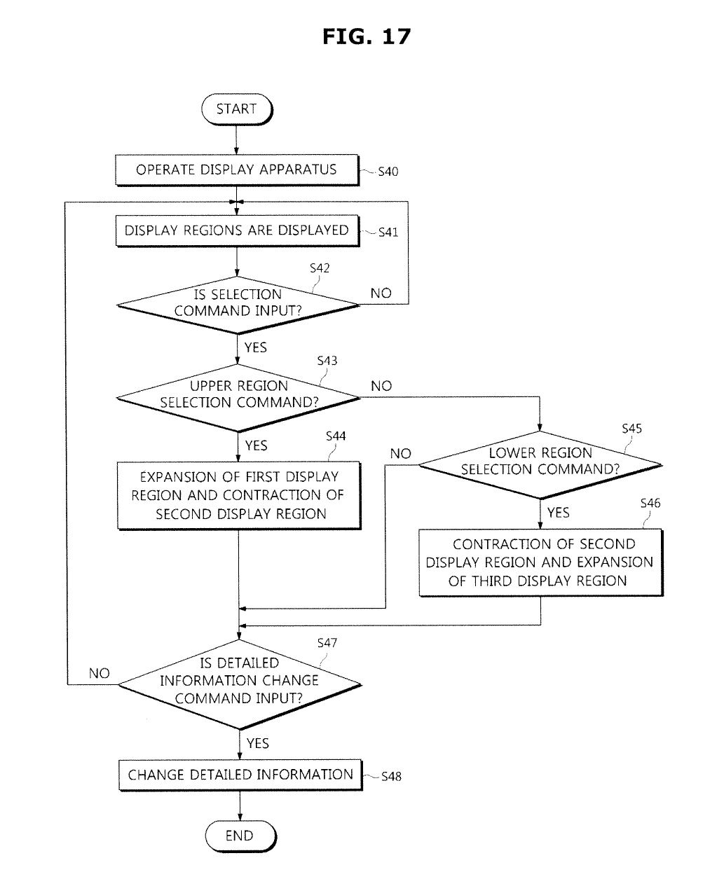

Hereinafter, a method of controlling the display apparatus for a vehicle will be explained with reference to FIG. 17. FIG. 17 is a flowchart illustrating an exemplary embodiment of a method of controlling the display apparatus for a vehicle.

Referring to FIG. 17, the display apparatus 1 for a vehicle may start operation according to power application to the vehicle, starting of the vehicle or user manipulation at operation S40.

The display apparatus 1 for a vehicle may display the display regions 210, 220 and 230 on the screen 201 at operation S41. In this case, as shown in FIGS. 5 through 16, the display regions 210, 220 and 230 may be arranged in sequence from top to bottom on the screen 201. Any one of the display regions 210, 220 and 230 may be expanded to display detailed information, and the other display regions may be contracted to display brief information. The display region to be expanded or contracted may be decided by predetermined settings. For example, only the specific display region may be expanded, or an arbitrarily selected display region may be expanded. In addition, the display region that has been in an expanded state just before the display apparatus 1 for a vehicle is terminated may be expanded. In addition, the display region selected by a user may be expanded. The information displayed on the display regions 210, 220 and 230 may include at least one of information related to future traveling, information related to a present traveling state and information related to past traveling.

Hereinafter, for convenience of explanation, the embodiment in which the intermediate second display region 220 is expanded to display detailed information and the first and third display regions 210 and 230 are contracted to display brief information as shown in FIG. 10 will be described.

When a user, e.g., a driver inputs a selection command by manipulating the input unit 10 at operation S42, if it is determined that the selection command input by a user is an upper region selection command at operation S43, the first display region 210 arranged above the second display region 220 may be expanded to display detailed information, and the second display region 220 may be contracted to display brief information at operation 844. The expansion of the first display region 210 may be achieved by increase in height of the first display region 210. The contraction of the second display region 220 may be achieved by decrease in height of the second display region 220.

If it is determined that the selection command input by a user is a lower region selection command at operation 845. the third display region 230 arranged below the second display region 220 may be expanded to display detailed information, and the second display region 220 may be contracted to display brief information at operation S46.

If a user, e.g., a driver inputs a detailed information change command by manipulating the input unit 10 at operation 847. the detailed information displayed on the second display region 220 which is in an expanded state may be changed at operation S48.

If no command is input, the second display region 220 may be maintained in an expanded state to display detailed information, and the other display regions 210 and 230 may be maintained in a contracted state to display brief information.

Although it has been described that the above processes are performed by user manipulation with respect to the input unit 10, the above processes may also be performed without user manipulation with respect to the input unit 10 when specific information displayed on the other display regions 210 and 230 needs to be displayed in detail.

The above processes may be repeated according to circumstance.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A display apparatus for a vehicle comprising:
a display unit including a plurality of display regions to respectively display information thereon; and
an input unit configured to receive a selection command to select one of the display regions,
wherein the display region selected according to the selection command is expanded to display detailed information, and the display region other than the selected display region displays brief information.

2. The display apparatus for a vehicle according to claim 1, wherein the display regions are arranged in sequence from top to bottom.

3. The display apparatus for a vehicle according to claim 2, wherein the selected display region is expanded by increase in height thereof according to the selection command, and the display region other than the selected display region is contracted by decrease in height thereof according to the selection command.

4. The display apparatus for a vehicle according to claim 2, wherein the selection command includes an upper region selection command or a lower region selection command.

5. The display apparatus for a vehicle according to claim 4, wherein if the upper region selection command is input, a display region arranged above a previously selected display region is expanded to display detailed information according to the upper region selection command, and the previously selected display region is contracted to display brief information.

6. The display apparatus for a vehicle according to claim 1, wherein the display regions are configured to display at least one of information related to future traveling of a vehicle, information related to a present traveling state of a vehicle, and information related to past traveling of a vehicle.

7. The display apparatus for a vehicle according to claim 6, wherein the display regions further display information related to vehicle inspection and user settings.

8. The display apparatus for a vehicle according to claim 1, wherein the input unit is configured to receive a detailed information change command, and the detailed information displayed on the selected display region is changed according to the detailed information change command.

9. The display apparatus for a vehicle according to claim 1, wherein the input unit includes at least one of a scroll wheel, a button, a knob, a touchscreen, a touch pad, a lever, a trackball, a motion sensor and a voice recognition sensor.

10. A vehicle comprising:
a display unit including a plurality of display regions; and
an input unit configured to receive a selection command to select one of the display regions,
wherein the display region selected according to the selection command is expanded to display detailed information, and the display region other than the selected display region displays brief information.

11. The vehicle according to claim 10, wherein the input unit is mounted to at least one of a steering wheel, a dashboard, a center fascia, a gearbox and a console box.

12. The vehicle according to claim 10, wherein the display unit is mounted to at least one of a gauge panel, a center fascia and a console box.

13. A method of controlling a display apparatus for a vehicle, comprising:
receiving a selection command to select one of a plurality of display regions; and
displaying detailed information on the selected display region, the selected display region being expanded according to the selection command, and brief information on the other display region, the other display region being contracted according to the selection command.

14. The method according to claim 13, wherein the display regions are arranged in sequence from top to bottom.

15. The method according to claim 14, wherein the displaying includes increasing the selected display region in height according to the selection command and decreasing the other display region in height according to the selection command.

16. The method according to claim 14, wherein the selection command includes an upper region selection command or a lower region selection command.

17. The method according to claim 15, wherein the displaying includes displaying detailed information on a display region arranged above a previously selected display region according to the upper region selection command, the display region arranged above the previously selected display region being expanded, and displaying brief information on the previously selected display region according to the upper region selection command, the previously selected display region being contracted.

18. The method according to claim 13, wherein the display regions display at least one of information related to future traveling of a vehicle, information related to a present traveling state of a vehicle, and information related to past traveling of a vehicle.

19. The method according to claim 13, further comprising:
receiving a detailed information change command; and
changing the detailed information displayed on the selected display region according to the detailed information change command.

20. The method according to claim 13, further comprising:
operating a display apparatus for a vehicle; and
displaying detailed information on one of the display regions, the one display region being expanded according to predetermined settings, and brief information on the other display region, the other display region being contracted according to predetermined settings.
